(19) United States
(12) Patent Application Publication
(10) Pub. No.: US 2010/0187800 A1
(43) Pub. Date: Jul. 29, 2010

(54) Reinforcement Member for Directly Jointed Tubular Components

(75) Inventors: Xiaoming N. Chen, Canton, MI (US); David Anthony Wagner, Northville, MI (US); Parameswararao Pothuraju, Canton, MI (US); Sunil K. Kasaragod, Canton, MI (US); Daniel Joseph Szalay, Belleville, MI (US)

Correspondence Address: MILLER LAW GROUP, PLLC;AND FORD GLOBAL TECHNOLOGIES, INC., 25 STEVENS AVENUE, WEST LAWN, PA, 19609, US

(73) Assignee: Ford Global Technologies, LLC

(21) Appl. No.: 12/362,476

(22) Filed: Jan. 29, 2009

(51) Int. Cl. B62D 21/00; B21D 53/88

(52) U.S. Cl. 280/785; 280/796; 180/311; 296/30; 29/897.2

(57) ABSTRACT

A reinforcement member is used to join directly two hydroformed tubular members in an automotive vehicle. The reinforcement member is formed with two spaced triangular plates joined to an orthogonal doubler plate in an integral configuration, providing mating surfaces for connection to orthogonally joined tubular members. The parallel triangular plates improve the joints vertical bending stiffness because the parallel plates provide an increased footprint at the joint. The parallel plates also enhance the lateral bending performance of the joint by locking relative movement of the two tubular members at the joint. The vertical doubler plate increases the thickness of the cross tubular member at the joint to allow a lighter gage tubular member to be utilized. The reinforcement member can be joined by MIG welding techniques on one side or on opposite sides of the cross tubular member for welding to the primary frame member.

### FIELD OF THE INVENTION

This invention relates to the use of tubular members in the construction of an automotive vehicle and, more particularly, to a reinforcement member for use where two tubular members are joined directly together.

### BACKGROUND OF THE INVENTION

Manufacturing processes for automobiles have evolved from one that utilized primarily stamped and bent sheet metal pieces that were welded together through a MIG welding processes, i.e. a welding process in which a line of molten material is deposited by the welder in joining two pieces of metal together. Now, conventional automobile manufacturing processes incorporate in a greater degree hydroformed tubular members, as well as tubular members formed through other manufacturing processes, that are shaped to fit into the chassis of an automobile in a desired manner. The tubular members are not typically conducive to being welded through a spot-welding process, which involves the passage of electrical current between two electrodes to melt and join two pieces of metal placed between the electrodes. Spot-welding requires a frame design that is conducive to being manufactured using the spot-welding process. For example, if two tubular members are being spot-welded together, access to the adjoining walls of the two tubular members by the spot-welder electrodes must be provided.

Hydroforming is a process by which a standard tubular stock member is placed into a form shaped to correspond to the particular member to be formed. A liquid is then introduced into the interior of the tubular stock and pressurized until the tubular stock expands to assume the shape defined by the configured form. The expanded and re-shaped tubular stock now has a substantially different shape. By forming cutouts and other access openings into the re-shaped tubular member, spot-welding electrodes can gain access to opposing adjacent sides to create a weld bond between juxtaposed members. In this manner, a frame, as an example, for an automobile can be created using in large part hydroformed tubular members.

Hydroformed tubular components have better load carrying capacity than conventional stamped parts that have been welded together. Hydroformed tubular components are being used as vehicle structure members for potential weight savings. The closed cross-section of hydroformed tubular components presents a challenge for joining the two members together directly. The conventional method for joining two tubular members is through brackets. As depicted in FIG. 1, the bracket 15 is a third member connecting two tubular components 10, 12 where the components 10, 12 are to be joined together. The bracket 15 interfaces with the two tubular components 10, 12 and can be welded to each of them. The stiffness of a joint formed with brackets 15 as shown in FIG. 1 is primarily defined by the bracket 15 and the connection mechanism between the respective tubular members 10, 12 and the bracket 15. The contribution of the tubular members 10, 12 is not as critical as the stiffness of bracket 15 interconnecting the two tubular members 10, 12. Accordingly, common design techniques are to provide big, heavy and complicated brackets 15 for joining tubular components 10, 12 to meet desired stiffness requirements for the vehicle. The use of these brackets 15 means more material and usually additional process steps and cost penalties.

Other techniques for directly joining two hydroformed tubular components 10, 12 have been developed in recent years. A typical example is the truck cross member to frame rail joint, as shown in FIG. 2. The tubular cross member 12 is pierced through the tubular frame rail 10, and connected with the rail by MIG (Metal Inert Gas) welding. This type of joint is weight efficient and occupies less space that with the bracket technique shown in FIG. 1. In addition, MIG weld is more rigid than rivets and bolt connections. The disadvantage of the joint technique depicted in FIG. 2 is size limitation. Hydroformed tubes have constant peripheries that eliminate the possibility of a bigger footprint of the joint, which would increase the stiffness and strength of the joint. Hydroformed tubular members are good candidates to build lightweight vehicle components; however, it is important to join the tubular members with desired stiffness qualities without adding extra weight to the structure.

An extruded corner connecting member with grooves formed to mate with building frame members is disclosed in U.S. Pat. No. 4,230,361, issued to Roland Nachbur, et al on Oct. 28, 1980, while a similar multiple piece configuration of the corner connecting member for building construction is shown in U.S. Pat. No. 5,116,161, granted on May 26, 1992, to Dieter Faisst. Brackets used to join two frame components in an automotive vehicle have been in use for many years, as can be seen in U.S. Pat. No. 2,380,523, granted to Harold Hicks, et al on Jul. 31, 1945. A similar bracket used to connect three sheet metal floor pan components is depicted in U.S. Pat. No. 5,829,824, issued on Nov. 3, 1998, to Shiro Yamamuro, et al.

Brackets are also used for mounting subframe components, such as suspension components, in automotive vehicles, as can be seen in U.S. Pat. No. 6,398,262, granted to James Ziech, et al on Jun. 4, 2002; and in U.S. Pat. No. 6,893,082, issued to Shigeki Watanabe on May 17, 2005. A connecting piece having the same contour as the main constituting member in a vehicle body structure is disclosed in U.S. Pat. No. 6,428,048, granted on Aug. 6, 2002, to Yuji Maki. U.S. Design Pat. No. D437,282, granted to Ronald Joll on Feb. 6, 2001, disclosed a triangularly shaped mounting bracket for an air brake reservoir on a railway car.

Japanese Patent Publication No. JP59-057072, dated Apr. 2, 1984, discloses a framework coupling structure for a vehicle to provide geometric access that facilitates welding at an angled joint in a vehicle. Japanese Publication No. JP63-215468, dated Aug. 7, 1988, discloses extension pieces for structural members to have a projection part for joining the members and improve the connection therebetween. While this reference addresses the joining of structural members, the design changes the design geometry of the members being joined, rather than add a reinforcement member. Japanese Publication No. 05-131953, dated May 28, 1993, discloses a design that improves the rigidity of a joint by providing a bracket that forms a closed section at a body mount.

It would be desirable to provide a reinforcement member that will improve the strength and stiffness of a joint formed by two directly connected hydroformed tubular members.

### SUMMARY OF THE INVENTION

It is an object of this invention to overcome the aforementioned disadvantages of the known prior art by providing a reinforcement member that can be utilized to join directly two hydroformed tubular members in forming vehicle body structures.

It is another object of this invention to provide a three-way reinforcement for a direct tubular joint construction in an automotive vehicle.

It is an advantage of this invention that the use of the reinforcement member increases the strength and rigidity of directly joined tubular members.

It is a feature of this invention that the reinforcement member is formed in a triangular shape to mate with a pair of orthogonally joined tubular members.

It is another feature of this invention that the reinforcement member can be mounted on one of the tubular members before being connected to the second tubular member.

It is another advantage of this invention that the reinforcement member provides three plates for reinforcing the tubular joint.

It is still another feature of this invention that the reinforcement member is formed with three plates configured into an integral member with two plates extending orthogonally from the third plate.

It is still another advantage of this invention that the vertical plate operates as a doubler against one of the tubular members to increase the section of the tubular member at the joint connection.

It is still another object of this invention to provide a reinforcement member for a joint between two tubular components so that at least one of the tubular members can be formed as a lighter member without compromising the strength and rigidity at the joint.

It is yet another object of this invention to provide a reinforcement member for two directly joined tubular members in an automotive vehicle that is durable in construction, inexpensive of manufacture, carefree of maintenance, facile in assemblage, and simple and effective in use.

These and other objects, features and advantages are accomplished according to the instant invention by providing a reinforcement member for use to join directly two hydroformed tubular member in an automotive vehicle. The reinforcement member is formed with two spaced triangular plates joined to an orthogonal doubler plate in an integral configuration, providing mating surfaces for connection to orthogonally joined tubular members. The parallel triangular plates improve the joints vertical bending stiffness because the parallel plates provide an increased footprint at the joint. The parallel plates also enhance the lateral bending performance of the joint by locking relative movement of the two tubular members at the joint. The vertical doubler plate increases the thickness of the cross tubular member at the joint to allow a lighter gage tubular member to be utilized. The reinforcement member can be joined by MIG welding techniques on one side or on opposite sides of the cross tubular member for welding to the primary frame member.

### BRIEF DESCRIPTION OF THE DRAWINGS

The advantages of this invention will become apparent upon consideration of the following detailed disclosure of the invention, especially when taken in conjunction with the accompanying drawings wherein:

FIG. 1 is a perspective view of a prior art technique for joining two tubular components with a third mounting bracket interconnecting the two tubular members;

FIG. 2 is a perspective view of a second prior art joining technique for connecting two tubular members directly by piercing the cross member into the primary frame member;

FIG. 3 is an opposing perspective view of the second prior art joining technique shown in FIG. 2;

FIG. 4 is perspective view of the reinforcement member incorporating the principles of the instant invention welded to a cross member before being joined to a primary frame member of the vehicle;

FIG. 5 is a perspective view of the reinforcement member welded to both the tubular cross member and the primary frame member on one side of the cross member;

FIG. 6 is an enlarged perspective view of the direct joint of tubular members shown in FIG. 5;

FIG. 7 is a perspective view similar to that of FIG. 5, but with a reinforcement member welded to both opposing sides of the cross member and to the adjacent wall of the primary frame member;

FIG. 8 is a perspective view of the cross member having a reinforcement member welded thereto on one side prior to being connected to the primary frame member;

FIG. 9 is a perspective view similar to that of FIG. 5, but having the reinforcement member oriented with the doubler plate positioned against the primary frame member to be welded thereto, the parallel triangular plates being welded to the cross member; and

FIG. 10 is an enlarged perspective view of the reinforcement member similar to that of FIG. 4, but showing an alternative configuration with the doubler plate connected to the cross member by detachable fasteners.

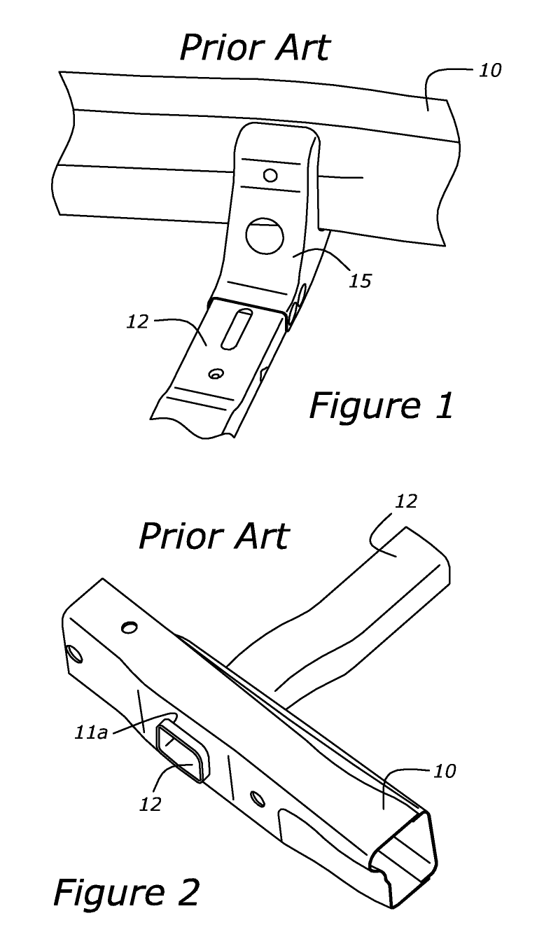

### DETAILED DESCRIPTION OF THE PREFERRED EMBODIMENT

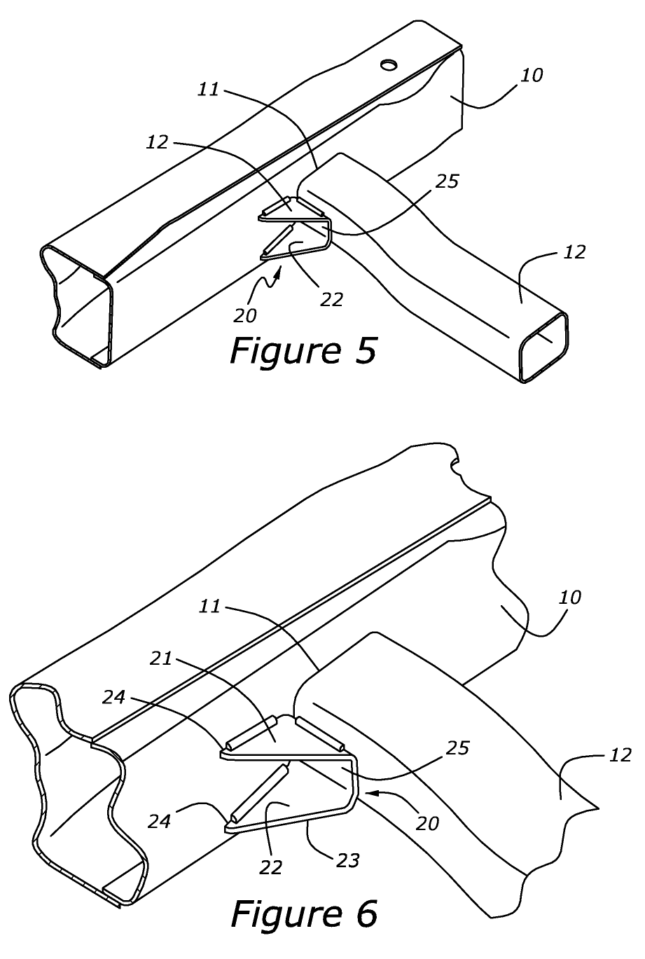

Referring to FIGS. 4-10, a reinforcement member for directly joined hydroformed tubular components incorporating the principles of the instant invention can best be seen. The reinforcement member 20 is formed with a triangularly shaped top plate 21 and a correspondingly shaped bottom plate 22 oriented parallel to the top plate 21 and spaced therefrom. Each of the top and bottom plates 21, 22 extends from opposing sides of a rectangularly shaped vertical plate 25 that is oriented perpendicularly to the top and bottom plates 21, 22. Each of the top and bottom plates 21, 22 is oriented such that a base side of the triangular shape is joined to the vertical plate 25 with the hypotenuse 23 extending from the vertical plate 25 to a distal point. Accordingly, the opposing base side 24 and the hypotenuse side 23 present mating edges for joining to tubular components, such as the primary tubular frame member 10. The top, bottom and vertical plates 21, 22 and 25 are integrally formed, such as through a stamping process, and present an integrated component.

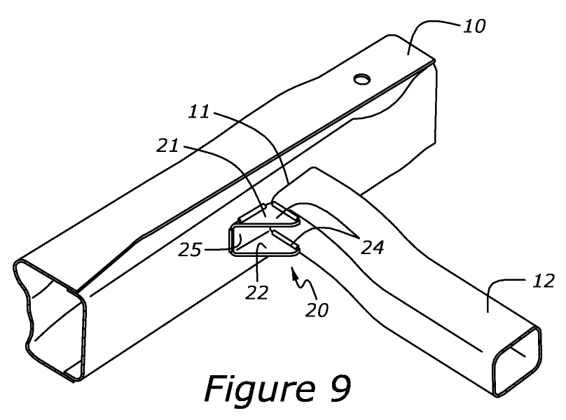

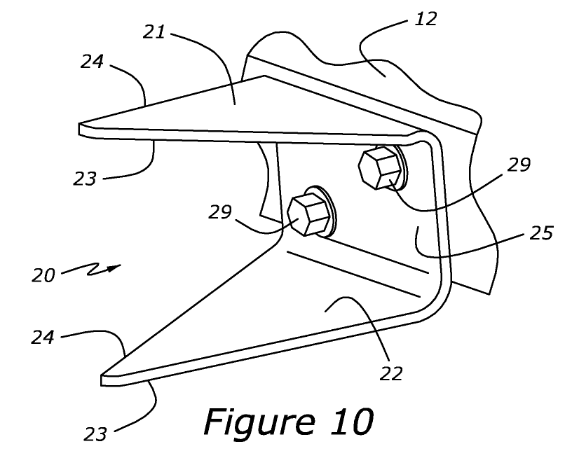

The vertical plate 25 serves as a doubler by presenting a mating surface to be affixed to a tubular member, such as the tubular cross member 12. When joined to the tubular cross member 12, as is shown in FIGS. 4-6, the vertical plate 25 increases the effective thickness of the tubular cross member 12 adjacent to the joint thereof with the primary tubular frame member 10. The vertical plate 25 is preferably welded to the tubular cross member 12, as is seen in FIGS. 4-6, but alternatively can be detachably connected to the tubular cross member 12 by fasteners 29, as is depicted in FIG. 10. In some circumstances the primary tubular frame member 10 requires the additional material thickness, so the reinforcement member 20 can be affixed to the primary tubular frame member 10 with the vertical plate 25 welded to primary tubular frame member 10, as is depicted in FIG. 9, or affixed by fasteners, with the mating surfaces 24 of the top and bottom plates 21, 22 welded to the tubular cross member 12.

The reinforcement member 25 is used to reinforce directly jointed tubular members 10, 12. The typical joint between two tubular members 10, 12 has at least two corners where the tubular cross member 12 extends into the primary tubular frame member 10. The reinforcement member 25 is shaped to fit into one of these corners with the vertical plate 25 affixed to one tubular member and the mating edges 24 of the top and bottom plates 21, 22 affixed to the joined tubular member. The connection of the reinforcement member 25 to the joined tubular members 10, 12, allows the triangularly shaped top and bottom plates 21, 22 to serve as gussets between the two tubular members 10, 12.

Each of the three plates 21, 22 and 25 plays a role in building a three-way reinforcement to the joint between the two tubular members 10, 12. The top and bottom plates 21, 22 work as a pair to improve the structure's vertical bending stiffness because the top and bottom plates 21, 22 generate a bigger footprint between the members 10, 12 at the joint. The top and bottom plates 21, 22 will also enhance the lateral bending performance of the joint by locking relative movement between the two tubular members 10, 12 at the joint. The vertical plate 25 is designed to be attached to the tubular member 10, 12 that requires local reinforcement. As is particularly pertinent for hydroformed tubular members, but also for tubular members formed through other manufacturing processes, the vertical plate 25 creates an opportunity to use lower gage tubes in the creation of the tubular members 10, 12 for some structures having high demands on joints. For example, a truck frame may not need to utilize large, heavy tubular cross members 12 if the joint between the tubular cross member 12 and the primary tubular rail member 10 is sufficiently strong and stiff.

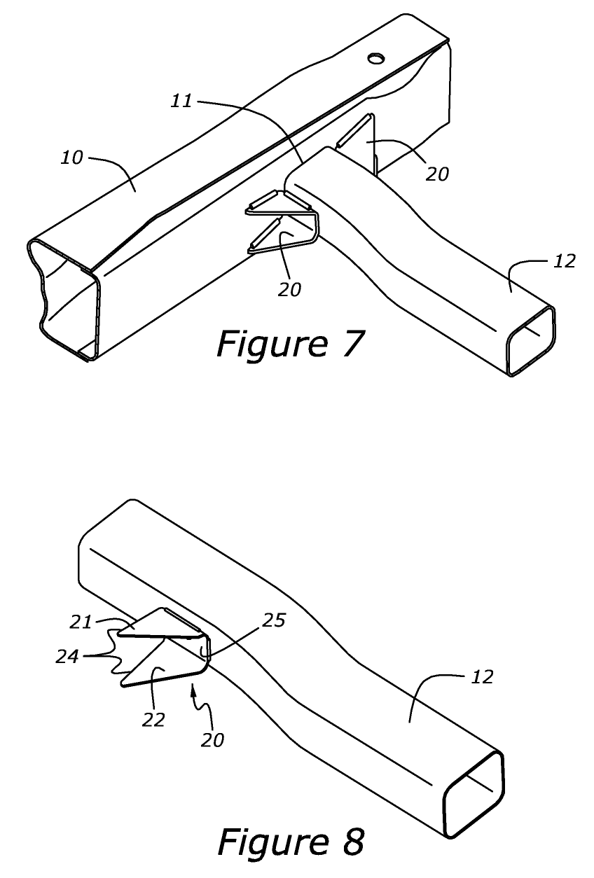

When a lighter tubular cross member 12 is selected, the vertical plate 25 will be attached to the tubular cross member 12 at the joint location. The vertical plate 25 acts as a doubler and will help build a strong joint without increasing the thickness of the tubular cross member 12. Computer simulations have demonstrated that the reinforcement member 20 will improve the global bending stiffness, lateral bending frequency, and match boxing frequency of a truck frame. The specific dimensions of the top, bottom and vertical plates 21, 22 and 25 of the reinforcement member 20 are determined by the size of the tubular members 10, 12 that form the joint, as well as the stiffness and frequency targets of the resulting vehicle structure. The reinforcement member 20 can be placed on one side of the joint or on both side of the joint, as depicted in FIG. 7, depending on the requirement for joint stiffness. The three plates 21, 22 and 25 of the reinforcement member 20 are not isolated parts. The top, bottom and vertical plates 21, 22 and 25 work together to build a strong and stiff joint formed of two tubular members 10, 12, and form an integrated component 20 for assembly.

The proposed method to assemble the three-way reinforcement member 20 to a joint formed from two tubular members 10, 12 includes the following steps: First, MIG weld the vertical plate 25 to the wall of one of the tubular members 10, 12 in a sub-assembly operation. Then, MIG weld the mating edge 24 of each of the top and bottom plates 21, 22 to the other tubular member 10, 12 during assembly of the vehicle frame. As an alternative, the first step could use detachable fasteners 29 to connect the vertical plate 25 to one of the tubular members 10, 12, as is reflected in FIG. 10. Depending on the specific configuration of tubular members 10, 12, the attachment of the vertical plate 25 to the corresponding tubular member 10, 12 can occur before or after the step of welding the mating edges 24 of the top and bottom plates 21, 22 to the other tubular member 10, 12. Furthermore, depending of the specific configuration and specific dimensions of the reinforcement member 20 and the desired orientation of the tubular members 10, 12 at the joint, the step of welding the edges of the top and bottom plates 21, 22 to the other of the tubular members 10, 12 could involve the hypotenuse 23 instead of the opposing base member mating edge 24.

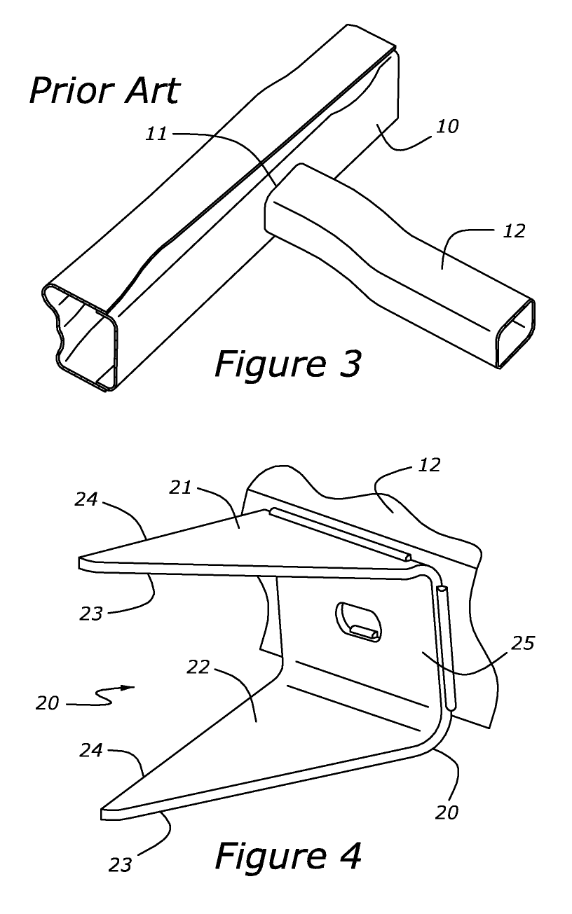

Preferably, the reinforcement member 20 will be affixed first to the tubular cross member 12 that will be received into the primary tubular frame member 10 in the sub-assembly operation by securing the vertical plate 25 to the wall of the tubular cross member 12 at a distance from the end of the tubular cross member 12 substantially equal to the depth of the primary tubular frame member 10 that will be pierced by the tubular cross member 12. The tubular cross member 12 is then inserted into a formed opening 11 in the primary tubular frame member 10, as shown in FIGS. 2 and 3, and preferably extending through an opposing opening 11a. At this location, the top and bottom plates 21, 22 will have the mating edges 24 butted against the primary tubular frame member 10. The tubular cross member 12 can then be welded to the primary tubular frame member 10 at both the openings 11 and 11a, and the mating edges 24 can be welded to the primary tubular frame member 10.

One skilled in the art will recognize that changes in the details, materials, steps and arrangements of parts which have been described and illustrated to explain the nature of the invention will occur to and may be made by those skilled in the art upon a reading of this disclosure within the principles and scope of the invention. The foregoing description illustrates the preferred embodiment of the invention; however, concepts, as based upon the description, may be employed in other embodiments without departing from the scope of the invention.

Having thus described the invention, what is claimed is:

1. In an automotive vehicle body having a joint formed by first and second tubular members with the first tubular member extending into the second tubular member to form the joint therebetween, the improvement comprising:
a reinforcement member having a top plate and a bottom plate oriented generally parallel and affixed to one of the tubular members, and a vertical plate joined with the top and bottom plates and affixed to the other of the tubular members.

2. The automotive vehicle body of claim 1 wherein the top and bottom plates form an integral reinforcement member with the vertical plate.

3. The automotive vehicle body of claim 2 wherein the vertical plate is affixed to the first tubular member and serves as a doubler to increase an effective material thickness of the first tubular member adjacent the joint with the second tubular member.

4. The automotive vehicle body of claim 3 wherein the top and bottom plates serve as gussets extending between the first and second tubular members.

5. The automotive vehicle body of claim 4 wherein the top and bottom plates are triangularly shaped and the vertical plate is rectangularly shaped.

6. The automotive vehicle body of claim 5 wherein the vertical plate is welded to the first tubular member and edges of the top and bottom plates mating with the second tubular member are welded to the second tubular member.

7. The automotive vehicle body of claim 5 wherein the vertical plate is affixed to the first tubular member by detachable fasteners, the top and bottom plates mating with the second tubular member are welded to the second tubular member.

8. The automotive vehicle body of claim 5 wherein the first tubular member has reinforcement members affixed to opposing sides thereof, each of the top and bottom plates being welded to the second tubular member.

9. A structural joint in an automotive vehicle comprising:
a first hydroformed tubular member;
a second hydroformed tubular member receiving the first tubular member, the first tubular member piercing into the second tubular member;
a reinforcement member having a top plate, a bottom plate spaced from and oriented parallel to the top plate, and a vertical plate joined to the top and bottom plates in an orthogonal orientation thereto, the vertical plate being affixed to one of the tubular members and corresponding edges of the top and bottom plates being welded to the other of the tubular members.

10. The structural joint of claim 9 wherein the top and bottom plates form an integral reinforcement member with the vertical plate.

11. The structural joint of claim 10 wherein the vertical plate is affixed to the first tubular member and serves as a doubler to increase an effective material thickness of the first tubular member adjacent the joint with the second tubular member, the top and bottom plates serving as gussets extending between the first and second tubular members.

12. The structural joint of claim 11 wherein the top and bottom plates are triangularly shaped and the vertical plate is rectangularly shaped.

13. The structural joint of claim 12 wherein the vertical plate is affixed to the first tubular member by detachable fasteners.

14. The structural joint of claim 12 wherein the vertical plate is welded to the first tubular member.

15. The structural joint of claim 14 wherein the first tubular member has reinforcement members affixed on opposing sides thereof, each of the top and bottom plates being welded to the second tubular member.

16. A method of forming a joint between first and second hydroformed tubular members in an automotive vehicle body comprising the steps of:
affixing a vertical plate of a first reinforcement member to the first tubular member at a location spaced from an end of the first tubular member;
joining the first tubular member to the second tubular member such that parallel top and bottom plates of the first reinforcement member oriented substantially orthogonally to the vertical plate are positioned against the second tubular member;
welding the first and second tubular members together; and
securing mating edges of the top and bottom plates to the second tubular member by welding.

17. The method of claim 16 wherein the joining step includes the step of:
inserting the first tubular member through an opening formed into the second tubular member for the passage of the first tubular member.

18. The method of claim 17 wherein the affixing step includes the step of welding the vertical plate to the first tubular member.

19. The method of claim 17 wherein the affixing step includes the step of fastening the vertical plate to the first tubular member with detachable fasteners.

20. The method of claim 17 further comprising the steps of:
connecting a vertical plate of a second reinforcement member to the first tubular member opposite the first reinforcement plate; and
after the joining step, securing mating edges of substantially parallel top and bottom plates of the second reinforcement member to the second tubular member.
